(19) United States
(12) Patent Application Publication
(10) Pub. No.: US 2004/0215470 A1
(43) Pub. Date: Oct. 28, 2004

(54) Providing services with respect to a building according to a projected future condition of the building

(75) Inventor: William Kress Bodin, Austin, TX (US)

Correspondence Address: IBM CORP (BLF), c/o BIGGERS & OHANIAN, LLP, 504 LAVACA STREET, SUITE 970, AUSTIN, TX, 78701-2856, US

(73) Assignee: INTERNATIONAL BUSINESS MACHINES CORPORATION, Armonk, NY

(21) Appl. No.: 10/418,608

(22) Filed: Apr. 17, 2003

(51) Int. Cl. G06F 17/60

(52) U.S. Cl. 705/1

(57) ABSTRACT

Providing services with respect to a building, including depicting a building in a data model, the data model including a three-dimensional representation of the building, a current condition of the building, a projected future condition of the building, and, optionally, one or more previous conditions of the building, projecting the future condition of the building in dependence upon the current condition of the building and, optionally, in dependence upon one or more previous conditions of the building, and tailoring services with respect to the building in dependence upon the projected future condition of the building

### BACKGROUND OF THE INVENTION

1. Field of the Invention

The field of the invention is data processing, or, more specifically, methods, systems, and products for providing services for a building according to automated reporting of the current condition of the building.

2. Description of Related Art

Consider a fireman approaching a burning house. The fireman knows only that an alarm was presented from the address of the house. As the fireman approaches, the fireman sees smoke rising from an upstairs window. The fireman does not know what kind of room is behind the window. The fireman does not know the temperature in the room behind the window or in other rooms of the house. The fireman does not know whether smoke is in other rooms of the house.

Consider a police officer approaching a building in which a security alarm has called a security service which in turn called the police. The police officer is the first to arrive on the scene. The police officer does not know whether an intruder is present in the building If an intruder is in the building, the officer does not know where.

It would be advantageous for providers of services with respect to buildings to be informed of conditions inside buildings, so that services could be tailored in dependence upon actual conditions in buildings. It would be advantageous also for providers of services with respect to buildings to be informed of projected future conditions inside the buildings, so that services could be tailored in dependence upon such projections.

### SUMMARY OF THE INVENTION

Exemplary embodiments of the invention include methods for providing services with respect to a building. Exemplary embodiments include depicting a building in a data model, the data model including a three-dimensional representation of the building, a current condition of the building, a projected future condition of the building, and, optionally, one or more previous conditions of the building. Such embodiments include projecting the future condition of the building in dependence upon the current condition of the building and, optionally, in dependence upon one or more previous conditions of the building, and tailoring services with respect to the building in dependence upon the projected future condition of the building

In exemplary embodiments of the invention, depicting a building in a data model includes describing the building, including the projected future condition of the building in a markup language. In such embodiments, projecting the future condition of the building includes asserting into a rules base the current condition of the building, and querying the rules base for a projected future condition of the building. In typical embodiments, projecting the future condition of the building is carried out in dependence upon one or more previous conditions of the building.

In exemplary embodiments of the invention, projecting the future condition of the building includes statistically projecting the future condition of the building in dependence upon values of data describing the current condition of the building and values of data describing one or more previous conditions of the building. Such embodiments include receiving in a gateway computer, from sensors within the building, data describing the current condition of the building. In typical embodiments, tailoring services includes communicating the data model, including the future condition of the building, from the gateway computer to service providers who provide services with respect to the building.

In exemplary embodiments of the invention, tailoring services includes communicating the data model expressed in a markup language, including the projected future condition of the building, from the gateway computer to service providers who provide services with respect to the building. Such embodiments include parsing the data model expressed in a markup language into a display format, and displaying an image of the building represented in the data model including projected future condition of the building. Typical embodiments include repeating in near-real-time the steps of projecting the future condition of the building and tailoring services with respect to the building.

Exemplary embodiments of the invention include methods for providing services with respect to a building. Exemplary embodiments include receiving at a service provider who provides services with respect to the building a data model expressed in a markup language, the data model including a three-dimensional representation of the building and a projected future condition of the building. Such embodiments include parsing the data model expressed in a markup language into a display format, and displaying an image of the building represented in the data model including the projected future condition of the building. Typical embodiments include altering the services provided with respect to the building in dependence upon the displayed image.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram of exemplary architecture useful in implementing methods for providing services with respect to buildings in accordance with embodiments of the present invention.

FIG. 2 sets forth a data flow diagram illustrating an exemplary method for providing services with respect to a building.

FIG. 3 sets forth a data flow diagram illustrating an additional exemplary method for providing services with respect to a building.

### DETAILED DESCRIPTION OF EXEMPLARY EMBODIMENTS

### Introduction

The present invention is described to a large extent in this specification in terms of methods for providing services for a building according to automated reporting of the current condition of the building. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

“802.11 ” refers to a family of specifications developed by the IEEE for wireless LAN technology. 802.11 specifies an over-the-air interface between a wireless client and a base station or between two wireless clients.

“API” is an abbreviation for “application programming interface.” An API is a set of routines, protocols, and tools for building software applications.

“Bluetooth” refers to an industrial specification for a short-range radio technology for RF couplings among client devices and between client devices and resources on a LAN or other network. An administrative body called the Bluetooth Special Interest Group tests and qualifies devices as Bluetooth compliant. The Bluetooth specification consists of a ‘Foundation Core,’ which provides design specifications, and a ‘Foundation Profile,’ which provides interoperability guidelines.

“Coupled for data communications” means any form of data communications, wireless, 802.11b, Bluetooth, infrared, radio, internet protocols, HTTP protocols, email protocols, networked, direct connections, dedicated phone lines, dial-ups, serial connections with RS-232 (EIA232) or Universal Serial Buses, hard-wired parallel port connections, network connections according to the Power Line Protocol, and other forms of connection for data communications as will occur to those of skill in the art. Couplings for data communications include networked couplings for data communications. Examples of networks useful with various embodiments of the invention include cable networks, intranets, extranets, internets, local area networks, wide area networks, and other network arrangements as will occur to those of skill in the art. The use of any networked coupling among television channels, cable channels, video providers, telecommunications sources, and the like, is well within the scope of the present invention.

“Field” and “data element,” unless the context indicates otherwise, generally are used as synonyms in this specification, referring to individual elements of digital data. Aggregates of data elements are referred to as “records” or “data structures.” Aggregates of records are referred to as “tables” or “files.” Aggregates of files or tables are referred to as “databases.” Complex data structures capable of including member methods, functions, or software routines as well as data elements are referred to as “classes.” Instances of classes are referred to as “objects” or “class objects.”

“HAVi” stands for ‘Home Audio Video interoperability,’ the name of a vendor-neutral audio-video standard particularly for home entertainment environments. HAVi allows different home entertainment and communication devices (such as VCRs, televisions, stereos, security systems, and video monitors) to be networked together and controlled from one primary device, such as a services gateway, PC, or television. Using IEEE 1394, the ‘Firewire’ specification, as the interconnection medium, HAVi allows products from different vendors to comply with one another based on defined connection and communication protocols and APIs. Services provided by HAVi's distributed application system include an addressing scheme and message transfer, lookup for discovering resources, posting and receiving local or remote events, and streaming and controlling isochronous data streams.

“HomePlug” stands for The HomePlug Powerline Alliance. HomePlug is a not-for-profit corporation formed to provide a forum for the creation of open specifications for high speed home powerline networking products and services. The HomePlug specification is designed for delivery of Internet communications and multimedia to homes through the home power outlet using powerline networking standards.

The HomePlug protocol allows HomePlug-enabled devices to communicate across power lines using Radio Frequency signals (RF). The HomPlug protocol uses Orthogonal Frequency Division Multiplexing (OFDM) to split the RF signal into multiple smaller sub-signals that are then transmitted from one HomPlug enabled-device to another HomePlug-enabled device at different frequencies across the powerline.

“HTTP” stands for ‘HyperText Transport Protocol,’ the standard data communications protocol of the World Wide Web.

“The Internet” is a global network connecting millions of computers utilizing the ‘internet protocol’ or ‘IP’ as the network layer of their networking protocol stacks. The Internet is decentralized by design. Each computer on the Internet is independent. Operators for each computer on the Internet can choose which Internet services to use and which local services to make available to the global Internet community. There are a variety of ways to access the Internet. Many online services, such as America Online, offer access to some Internet services. It is also possible to gain access through a commercial Internet Service Provider (ISP). An “internet” (uncapitalized) is any network using IP as the network layer in its network protocol stack.

“JES” stands for Java Embedded Server. JES is a commercial implementation of OSGi that provides a framework for development, deployment, and installation of applications and services to embedded devices.

“LAN” is an abbreviation for “local area network.” A LAN is a computer network that spans a relatively small area. Many LANs are confined to a single building or group of buildings.

However, one LAN can be connected to other LANs over any distance via telephone lines and radio waves. A system of LANs connected in this way is called a wide-area network (“WAN”). The Internet is an example of a WAN.

“OSGI” refers to the Open Services Gateway Initiative, an industry organization developing specifications for services gateways, including specifications for delivery of service bundles, software middleware providing compliant data communications and services through services gateways. The Open Services Gateway specification is a java based application layer framework that gives service providers, network operator device makers, and appliance manufacturer's vendor neutral application and device layer APIs and functions.

“SMF” stands for “Service Management Framework™” available from IBM®. SMF is a commercial implementation of OSGi for management of network delivered applications on services gateways.

“X-10” refers to the X-10 protocol, a powerline protocol. Typical X-10 enabled devices communicate across AC powerline wiring, such as existing AC wiring in a home, using an X-10 transmitter and an X-10 receiver. The X-10 transmitter and the X-10 receiver use Radio Frequency (RF) signals to exchange digital information. The X-10 transmitter and the X-10 receiver communicate with short RF bursts that encode digital information. In the X-10 protocol, data is sent in data strings called frames. The frame begins with a 4 bit start code designated as “1110.” Following the start code, the frame identifies a particular domain, such as house, with a 4 bit “house code,” and identifies a device within that domain with a 4 bit “devices code.” The frame also includes a command string of 8 bits identifying a particular preset command such as “on,” “off,” “dim,” “bright,” “status on,” “status off,” and “status request.”

“XML” stands for ‘eXtensible Markup Language,’ a language that support user-defined markup including user-defined elements, tags, and attributes. XML's extensibility contrasts with most web-related markup languages, such as HTML, which are not extensible, but which instead use a standard defined set of elements, tags, and attributes. XML's extensibility makes it a good foundation for defining other languages. WML, the Wireless Markup Language, for example, is a markup language based on XML. Modern browsers and other communications clients tend to support markup languages other than HTML, including, for example, XML.

### Exemplary Architecture

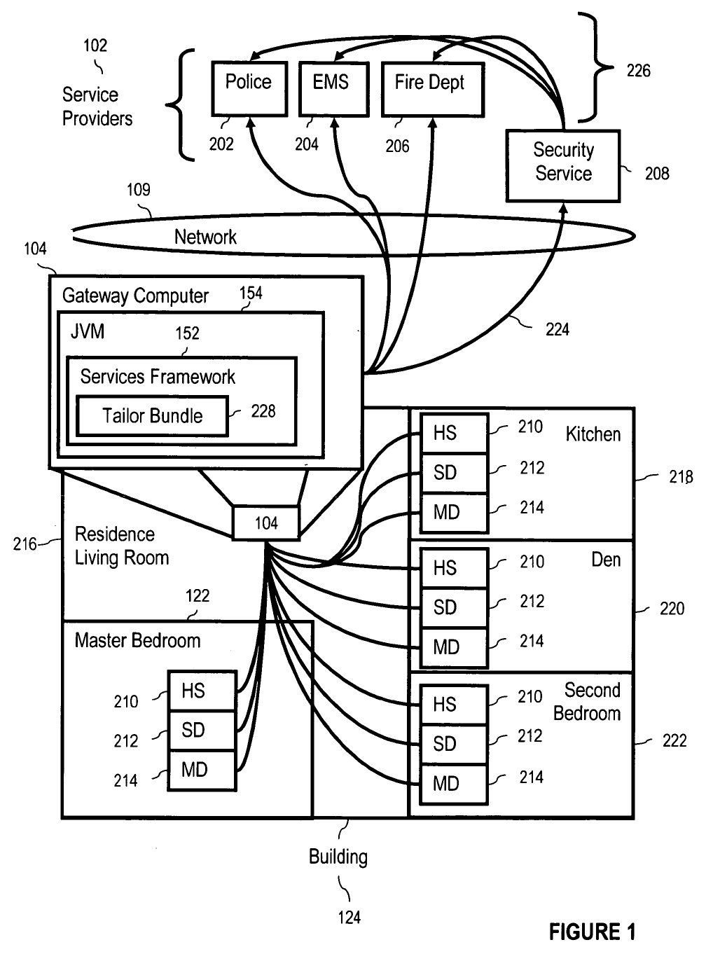

FIG. 1 is a block diagram of exemplary architecture useful in implementing methods for providing services with respect to buildings in accordance with embodiments of the present invention. In this disclosure, providing services ‘with respect to’ a building means providing service for the building or for occupants of the building. Firemen, for example, in putting out a fire and helping remove people from a burning building provide both a service to the building itself and also to its occupants.

An exemplary architecture according to FIG. 1 includes a building (124), represented in FIG. 1 as a two-dimensional block diagram of a residence comprising a living room (216), a master bedroom (122), a kitchen (218), a den (220), and a second bedroom (222). The selection of a residence as the exemplary building of FIG. 1 is for convenience of explanation, not for limitation of the invention. Methods and systems for providing services to buildings according to embodiments of the present invention are implemented with respect to any kind of building, office buildings, hospitals, factories, theatres, restaurants, and any others as will occur to those of skill in the art.

The exemplary residence of FIG. 1 includes a gateway computer (104). The exemplary residence of FIG. 1 includes sensors in several rooms, including heat sensors (210), smoke detectors (212), and motion detectors (214). In this example, each sensor is coupled for data communications to the gateway computer which in turn is coupled for data communications to service providers, or, rather, to computer systems of service providers. Service providers are entities who provide services with respect to the building (124). Examples of service providers include Internet service providers, private security services, police departments, emergency medical services, fire departments, and others as will occur to those of skill in the art.

A gateway computer in this example provides data processing for data from the sensors and also provides data communications with service providers (102). In typical embodiments, sensors (210, 212, 214) in a building (124) are coupled for data communications through a LAN to a gateway computer (104). A typical gateway computer is coupled for data communications across a WAN (109) to computers of service providers (102). A gateway computer (104) is a ‘gateway’ in the sense that it forms a portal through which data from internal sensors are communicated to external service providers. A gateway computer is a ‘gateway’ in the sense that it is a portal between two forms of data communications, the internal LAN protocols (which are often powerline protocols such as X-10 or wireless LAN protocols such as Bluetooth or 802.11b) and WAN protocols such as for example TCP/IP or HTTP.

The mention in this disclosure of particular protocols is for explanation, not for limitation. There is no limitation of the present invention to any particular protocols; systems providing services according to embodiments of the present invention carry out data communications internally to a building and externally according to any data communications protocol as will occur to those of skill in the art. Although as a practical matter in many embodiments of the present invention, LAN protocols within a building are different from external WAN protocols, that also is not a limitation of the invention. Both LANs and WANs may very well use TCP/IP or HTTP, for example.

In many embodiments of the present invention, the gateway computer (104) comprises an OSGi-compliant gateway computer. While exemplary embodiments of methods for providing services with respect to buildings are described generally in this specification by using OSGi as an example, many other applications and frameworks, will work to implement the methods of providing services with respect to buildings according to the present invention, and are therefore also well within the scope of the present invention. Commercial implementations of OSGi, such as JES and SMF, are also useful in implementing methods of the present invention.

The exemplary architecture of FIG. 1 includes a tailor bundle (228). In many typical embodiments of the architecture of FIG. 1, the tailor bundle (228) is application software useful in implementing methods of providing services with respect to buildings in accordance with the present invention. In fact, an application such as the illustrated tailor bundle typically carries out many of the automated steps of providing services to buildings according to embodiments of the present invention. In some embodiments of the present invention, an application such as the illustrated tailor bundle is OSGi compliant application software, and is therefore implemented as a service or a group of services packaged as an OSGi ‘bundle’ installed on an OSGi-compliant services framework (152).

In the exemplary architecture of FIG. 1, the gateway computer (104) includes a services framework (152). The services framework (152) of FIG. 1 is a hosting platform for running OSGi-compliant ‘services’. Services are the main building blocks for creating applications according to OSGi. An OSGi services framework (152) is Java software and therefore typically runs on a Java Virtual Machine (“JVM”) (154).

In this specification, applications for providing services with respect to buildings are often described in terms of OSGi and Java. The discussion of OSGI and Java in this specification, however, is for explanation and not for limitation. In fact, applications for providing services with respect to buildings according to various embodiments of the present invention can be implemented in any programming language, C, C++, COBOL, FORTRAN, BASIC, and so on, as will occur to those of skill in the art, and applications for providing services with respect to buildings developed in languages other than Java are installed, not only on JVMs, but also upon any operating system or operating environment as will occur to those of skill in the art.

### Tailoring Services According to a Projected Future Condition of a Building

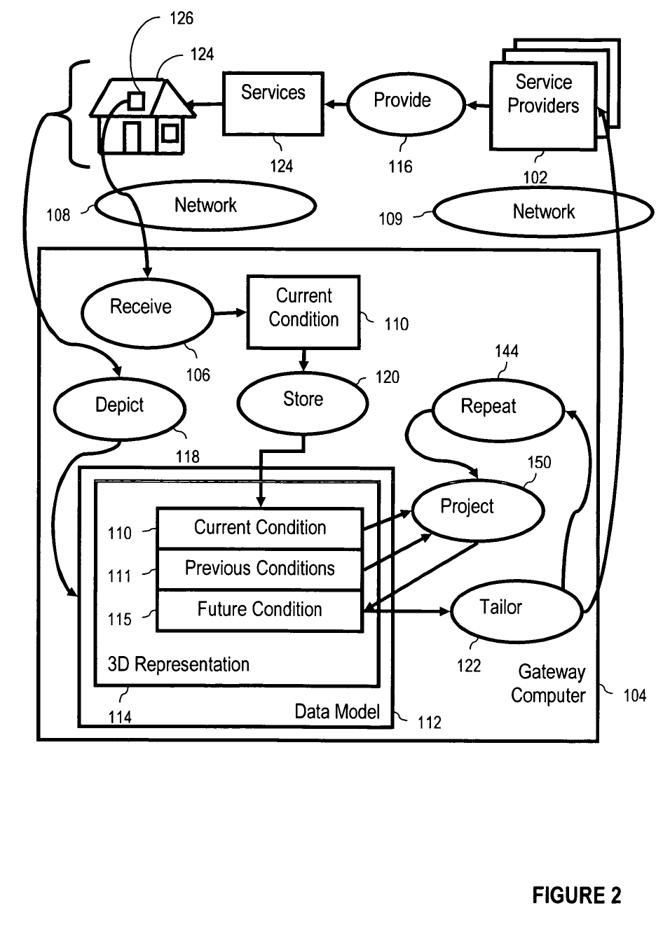

FIG. 2 sets forth a data flow diagram illustrating an exemplary method for providing services with respect to a building. The method of FIG. 2 includes depicting (118) a building (124) in a data model (112) where the data model comprising a three-dimensional representation (114) of the building, a current condition of the building (110), a projected future condition (115) of the building, and, optionally, one or more previous conditions of the building (111). Depicting (118) a building (124) in a data model (112) is carried out by use of any automated graphical design tool or computer aided design (“CAD”) tool as will occur to those of skill in the art including, for example, the AutoCad™ CAD product from the Autodesk, Inc., of San Rafael, Calif., and the IntelliCAD™ CAD product from CADopia LLC of San Diego, Calif. In many embodiments of the method according to FIG. 2, depicting (118) a building (124) in a data model (112) includes describing the building and the current condition of the building in a markup language. Some versions of automated design tools, including Autocad, for example, provide capabilities for representing descriptions of buildings in markup languages such as XML. Some versions of AutoCad, for example, include an XML schema called DesignXML™ that provides an ability to represent both graphical and nongraphical aspects of a building description.

In many exemplary embodiments, the method of FIG. 2 includes receiving (106) in a gateway computer (104), from sensors (126) within the building (124), data describing the current condition (110) of the building. In typical embodiments, receiving (106) data describing the current condition (110) of the building is implemented through LAN protocols such as, for example, X-10, Bluetooth, or 802.11 b. Data describing the current condition (110) of the building includes any descriptive data that can be electronically encoded and communicated including, for example, temperature, the existence of physical motion in a room, the existence of smoke in a room.

As mentioned above, in many embodiments of the method according to FIG. 2, the gateway computer (104) and the sensors (126) within the building (124) are coupled for data communications on a network (108) supporting one or more data communications protocols Often the network (108) is a LAN. In such embodiments, receiving (106) data describing the current condition (110) of the building (124) typically includes communicating data, between the gateway computer and the sensors within the building, according to at least one data communications protocol, such as, for example, X-10, Bluetooth, 802.11 b, or others as will occur to those of skill in the art.

Data describing the current condition (110) of the building includes not only the kinds of conditions that can be measured, but also the condition of equipment within a building To the extent that a network-enabled security system is installed in a building, for example, data describing the current condition (110) of the building includes data describing whether the security system is on or off, set or reset, enabled or disabled, and so on. To the extent that a network-enabled fire fighting system is installed in a building, for example, data describing the current condition (110) of the building includes data describing whether the fire fighting system is on or off, set or reset, enabled or disabled, and so on. To the extent that a gateway computer is installed in a building, for example, data describing the current condition (110) of the building includes data describing whether the gateway computer is on or off, set or reset, enabled or disabled, and so on.

Typically such embodiments include storing (120) the data describing the current condition (110) of the building, either storing in computer memory generally, for later use in projecting a future condition of the building, or storing in the data model (112) itself. Typical embodiments of the present invention often also store projected future conditions of buildings, either in computer memory generally or in a data model in particular. Data describing a current condition (110) of a building and projected future condition of a building is encoded and stored in any format as will occur to those of skill in the art, including text descriptions, icons representing particular conditions of a building, predefined animations depicting particular conditions of buildings, and even video clips of actual conditions.

Some embodiments maintain the data model in the form of a CAD drawing file as provided by AutoCAD or IntelliCAD, for example. Drawing file formats tend to be application-specific, however, so that many data models according to embodiments of the present invention are maintained and communicated in the form of markup files such as for example XML files or SGML files. In fact, in many embodiments of the method according to FIG. 2, depicting (118) a building (124) in a data model (112) includes describing the building, including the projected future condition (115) of the building, in a markup language. Data models can be implemented in XML as illustrated by the following example segment of XML.

```
<building id=“aResidence”>
    <condition id=“Security System” time=“1000”>Armed</condition>
    <futureCondition id=“building”
    time=“”>Burglarized</futureCondition >
    <futureCondition id=“building”
    time=“”>DestroyedByFire</futureCondition >
    <room id=“Living Room”>
        <condition id=“Motion Detector”
        time=“1001”>Negative</condition>
        <wall><condition id=“” time=“”></condition></wall>
        <wall></wall>
        <floor></floor>
        <ceiling><condition id=“” time=“”></condition><ceiling>
    </room>
    <room id=“Bedroom”>
        <condition id=“Motion Detector”
        time=“1002”>PositiveDetection</condition>
        <wall>
            <condition id=“Heat Sensor”
            time=“1003”>73 Degrees F</condition>
            <condition id=“Heat Sensor”
            time=“1004”>250 Degrees F</condition>
            <condition id=“Heat Sensor”
            time=“1005”>355 Degrees F</condition>
            <condition id=“Heat Sensor”
            time=“1006”>460 Degrees F</condition>
            <futureCondition id=“Heat Sensor”
            time=“1007”>550 Degrees F
            </futureCondition>
        </wall>
        <wall></wall>
        <floor><condition id=“” time=“”></condition></floor>
        <ceiling><ceiling>
    </room>
</building>
```

This example is simplified for purposes of explaining the inclusion of data describing current, previous, and projected future conditions of a building Persons of skill in the art will recognize that typical XML data models for 3D representations of buildings also include elements describing locations of the walls, ceilings, floors, and other objects in a 3D scene; vertices of walls, ceilings, floors, and other objects; planar and curvilinear surfaces of objects; lighting; shading; backgrounds; textures; and so on, as will occur to those of skill in the art, not shown here in support of clarity of explanation. This example shows a building identified as “aResidence” simplified by representing only two rooms, a “Living Room” and a “Bedroom,” and only a few data describing the current condition of the building.

In this example, projected future conditions are marked as such in separate elements: <futureCondition>. In this example, a current condition of the building is either the only data in the model describing a particular variable or, to the extent that the data includes time stamps, the latest data in the model describing the variable. Data describing previous conditions of a building are data bearing time stamps, so that all data earlier than the latest datum is considered data describing previous conditions. In the following excerpt, therefore:

```
<wall>
    <condition id=“Heat Sensor” time=“1003”>73 Degrees F</condition>
    <condition id=“Heat Sensor”
    time=“1004”>250 Degrees F</condition>
    <condition id=“Heat Sensor”
    time=“1005”>355 Degrees F</condition>
    <condition id=“Heat Sensor”
    time=“1006”>460 Degrees F</condition>
    <futureCondition id=“Heat Sensor” time=“1007”>550 Degrees F
    </futureCondition>
</wall>
```

the first three <condition> elements are data describing previous conditions of a building, that is, in particular, a temperature from a heat sensor in or on a wall. The fourth <condition> element sets forth data describe a current condition of the building And the <futurecondition> elements sets a projected future condition of the building in this example, the future condition is projected by use of statistical regression.

In this example, the building itself in this example has a <condition> element showing the current condition of a “Security System” as “Armed.” The <condition> elements in the “Living Room” are empty, but the <condition> element in the “Bedroom” shows a “Motion Detector” indicating that motion has been detected in the bedroom. In one wall of the bedroom, a <condition> element for a “Heat Sensor” indicates a temperature of 73 degrees Fahrenheit. Some elements in this XML segment contain <condition> elements and other do not. The <condition> elements typically are placed only in those other elements representing parts of a building where sensors are located, so that when the XML segment is rendered in a 3D image on a display, the data describing the current condition of a building can be displayed at the location on the image corresponding to the location from which it originated in the building.

The example of FIG. 2 includes projecting (150) the future condition (115) of the building (124) in dependence upon the current condition (110) of the building and, optionally, in dependence upon one or more previous conditions (111) of the building. As mentioned above, many embodiments store not only data describing current or previous conditions of a building, but also projected future conditions of a building, as illustrated by the elements from the example XML segment above:

<futureCondition id=“building” time=“”>Burglarized</futureCondition>
<futureCondition id=“Heat Sensor”
time=“1007”>550 Degrees F</ futureCondition >
<futureCondition id=“building”
time=“”>DestroyedByFire</futureCondition >

In some embodiments of the method according to FIG. 2, projecting (150) the future condition (115) of the building (124) includes asserting into a rules base the current condition of the building and querying the rules base for a projected future condition of the building In general, a ‘rules base,’ sometimes called a ‘knowledge base,’ is a centralized repository for information: a public library or a database of related information about a particular subject can both be considered examples of knowledge bases. In relation to computer technology, a knowledge base is a machine-readable resource for the dissemination of information, generally online or with the capacity to be put online.

This disclosure describes a rules base as a database of Prolog clauses comprising security facts and security rules. Prolog is a high-level programming language based on formal logic. Unlike traditional programming languages that are based on performing sequences of commands, Prolog is based on defining and then solving logical formulas. Prolog is sometimes called a declarative language or a rule-based language because its programs comprise lists of facts and rules. Facts and rules comprising Prolog programs are often stored in program files referred to as Prolog databases. A Prolog database comprising factual assertions and logical rules is correctly viewed as a knowledge base or rules base. In this disclosure, the utilization of Prolog is exemplary, not a requirement of the present invention. In addition to Prolog, many methods and means, and many computer languages, will occur to those of skill in the art for establishing rules bases, and all such methods, means, and languages are well within the scope of the present invention.

In the example of Prolog, a rules base, in this discussion, a rules base for providing services with respect to buildings, comprises Prolog clauses including facts and rules. Storing facts and rules in a security knowledge database is referred to as ‘asserting’ facts and rules. Conversely, facts and rules can be removed from a rules base by ‘retracting’ them. Facts and rules typically have a form similar to so-called predicate logic. For example, the following is an exemplary set of three Prolog clauses:

parent(fred, greta).

parent(greta, henry).

grandparent(X, Z):- parent(X, Y), parent(Y, Z).

Prolog clauses are normally of three types: Facts declare things that are true. Rules declare things that are true depending on a given condition. Questions are used to find out if a particular rule is presently satisfied by asserted facts, when the rule is said to be ‘true.’ Prolog questions are sometimes referred to as ‘goals’ or ‘queries.’ In the three-line example above, “parent(fred, greta) is a fact. “Parent” is a predicate. “Fred” is the first argument, sometimes called a ‘subject.’ “Greta” is the second argument, sometimes called an ‘object.’

In the three-line example above, “grandparent(X, Z):- parent(X, Y), parent(Y, Z).” is a rule. “Grandparent(X,Z)” is referred to as the ‘head’ of the rule. “Parent(X, Y), parent(Y, Z)” is referred to as the ‘body’ of the rule. “Parent(X, Y)” is the first subgoal of the rule. “Parent(Y, Z)” is the second subgoal of the rule. X, Y, and Z are variables.

This example rule is correctly described in several ways. One declarative description is: For all X and Z, X is a grandparent of Z if there exists some Y such that X is a parent of Y and Y is a parent of Z. Another declarative description is: For all X, Y and Z, if X is a parent of Y and Y is a parent of Z then X is a grandparent of Z. A procedural interpretation of the rule is: The goal grandparent(X, Z) succeeds with binding X1 for X and binding Z1 for Z if first, the goal parent(X, Y) succeeds with bindings X1 and Y1 and then the goal parent(Y, Z) succeeds with bindings Y1 and Z1.

A Prolog goal is said to ‘succeed’ if it can be satisfied from a set of clauses in a Prolog database. A goal fails if it cannot be so satisfied. For an example based upon the three-line set of example Prolog clauses set forth above: the query “grandparent(fred, X).” is satisfied with X instantiated to henry. On the other hand, the query “grandparent(fred, bob).” is not capable of being satisfied from the three-line exemplary Prolog database, because ‘bob’ does not appear in that set of clauses.

As a further aid to understanding, consider the following example Prolog program, an example that is useful in explaining methods of providing services with respect to buildings:

residenceAlarm(Armed).

motionDetected(Bedroom).

motionDetected(LivingRoom).

futureCondition(Burglarized):- residenceAlarm(Armed),

motionDetected(X).

This example rules base comprises four asserted facts and one rule. The facts are these:

the residence alarm is armed

motion is detected in the bedroom

no motion is detected in the living room

no motion is detected in the den

The example rule:

futureCondition(Burglarized):- residenceAlarm(Armed),

motionDetected(X).

says that the query “futureCondition(Burglarized)” succeeds, returns True, when the residence alarm is armed and any motion is detected in any room of the residence. In this particular example, the query “futureCondition(Burglarized)” succeeds because motion is detected in the bedroom. If the fact asserting motion in the bedroom were missing from the rules base, that is, not asserted, then the query “futureCondition(Burglarized)” would still succeed in this example because motion is also asserted to be detected in the living room.

For further explanation, here is a further example of a Prolog database for providing services with respect to buildings:

greaterThan(Temp, Bedroom, 500).

greaterThan(Temp, Kitchen, 500).

greaterThan(Temp, Den, 500).

futureCondition(DestroyedByFire):- greaterThan(X, 500).

The facts asserted in this example are:

the temperature in the bedroom is greater than 500 degrees F.

the temperature in the kitchen is greater than 500 degrees F.

the temperature in the den is greater than 500 degrees F.

The example rule:

futureCondition(DestroyedByFire):- greaterThan(Temp, X, 500). says that the query “futureCondition(DestroyedByFire)” succeeds if the temperature is greater than 500 degrees F. in any room. In this example, the query “futureCondition(DestroyedByFire)” would succeed because the temperature is asserted to be above 500 degrees in three rooms of a building.

Client code can utilize such Prolog databases through calls to Prolog APIs. Here is a example of client code, a pseudocode segment, showing how client code can run in a gateway computer to query a Prolog database to project a future conditions of a building and then insert into a data model one or more projected future conditions of the building

```
if(Prolog.query(“futureCondition(Burglarized)”)
    insertInModel(“<futureCondition id=/“building/”
        time=/“/”>Burglarized</futureCondition>”)
if(Prolog.query(“futureCondition(DestroyedByFire)”)
    insertInModel(“<futureCondition id=/“building/”
        time=/“/”>DestroyedByFire</futureCondition>”)
```

The method Prolog.query( ) is a call through an API provided by a Prolog implementation itself, for direct calls to Prolog methods. Many implementations of Prolog provide APIs. Examples of Prolog implementations that support APIs, including APIs for Java and/or C++, for example, readily available ‘off-the-shelf,’ as it were, include “Amzi! Prolog” from Amzi!, Inc.; “SICS Prolog” and “Quintus Prolog,” both from the Swedish Institute of Computer Science; “Jinni 2000” (Java INference Engine and Networked Interactor) from BinNet Corporation of Denton, Texas; and “MINERVA” from IF Computer Japan Limited, Tokyo.

In some embodiments of the method according to FIG. 2, projecting (150) the future condition (115) of the building (124) is carried out in dependence upon one or more previous conditions (111) of the building. Often in embodiments that include projecting (150) the future condition (115) of the building (124) in dependence upon one or more previous conditions (111) of the building, projecting (150) the future condition (115) of the building comprises statistically projecting the future condition of the building in dependence upon values of data describing the current condition of the building and values of data describing one or more previous conditions of the building.

Statistically projecting the future condition of the building in dependence upon values of data describing the current condition of the building and values of data describing one or more previous conditions of the building is particularly useful for data describing the condition of the building that is statistically linear, that is, either actually linear or amenable to treatment as if it were linear over some period of time. Examples of such data include measurements of temperature, pressure (as from strain gauges), light levels, sound pressure levels, and so on, as will occur to those of skill in the art.

Statistically projecting the future condition of the building in dependence upon values of data describing the current condition of the building and values of data describing one or more previous conditions of the building can be carried out by use of statistical regression methods taking as their inputs the values of data describing the current condition of the building and values of data describing one or more previous conditions of the building and producing as their output a model or expression modeling the future condition of the building as a function of time. Statistically projecting the future condition of the building then comprises calculating, according to the model or expression, values of one or more independent variables indicative of condition at a future point in time. Examples of statistical regression methods useful with various kinds of data in various embodiments of the present invention include linear regression (generally least-squares), nonlinear regression, variance analysis, and others as will occur to those of skill in the art.

The method of FIG. 2 also includes tailoring (122) services with respect to the building in dependence upon the projected future condition (115) of the building Consider an example illustrated by use of the XML segment above. In this example, tailoring (122) services (124) includes communicating to the police the projected future condition that the residence is about to be burglarized, a future condition projected from the current or previous conditions that the security system is armed (no one should be in the house) and there is a positive motion detection in the bedroom, indicating a possible intruder. A police officer approaches the house holding a PDA having displayed upon it the 3D representation of the house including an indication of the projected future condition of burglary. In this example, the officer is holding a wirelessly networked PDA coupled for communications to a security service provider through whom the 3D image of the residence, including the projected future condition, is communicated from the gateway computer in the house. If the projected future condition changes, a new projected future condition is quickly communicated to and displayed upon the police officer's PDA.

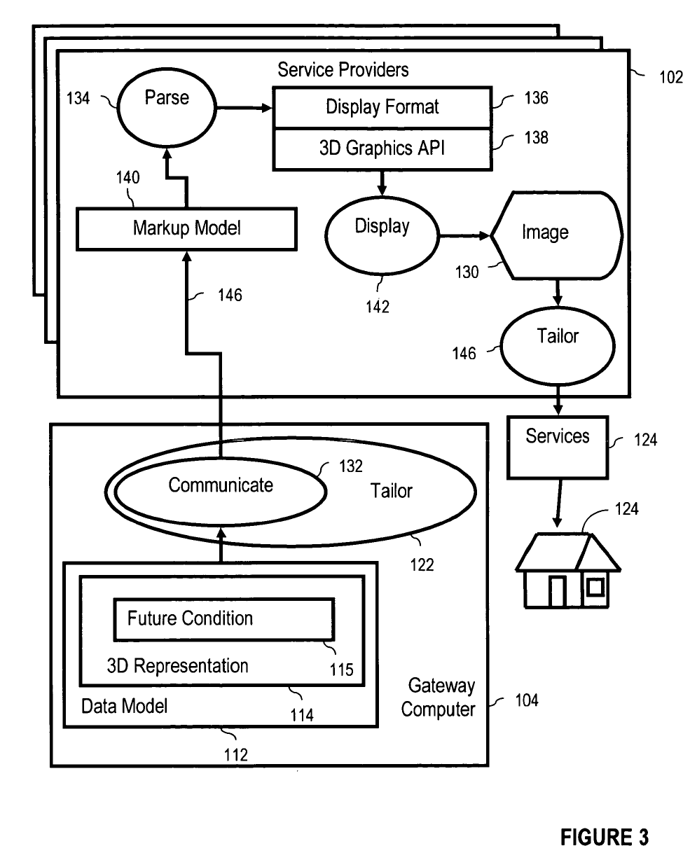

A more detailed explanation of tailoring services is presented with reference to FIG. 3. FIG. 3 sets forth a data flow diagram illustrating an additional exemplary method for providing services with respect to a building. In the method of FIG. 3, tailoring services (122) includes communicating (132) the data model (112), including the future condition (115) of the building (124), from the gateway computer (104) to service providers (102) who provide services (124) with respect to the building. In typical embodiments of the method of FIG. 3, tailoring services (122) further comprises communicating (132) the data model (112) expressed in a markup language (140), including the projected future condition of the building (115), from the gateway computer (104) to service providers (102) who provide services (124) with respect to the building.

The exemplary architecture of FIG. 1 illustrates two external communications paths for communications of data describing a projected future condition of a building In some examples, a gateway computer provides data describing a projected future condition of a building to an intermediary provider such as a security service or Internet Service Provider (“ISP”) (208), and the intermediary forwards the data describing the projected future condition of a building to pertinent service providers (226). In other exemplary embodiments, the gateway computer itself decides which service provider is pertinent to particular data describing the projected future condition of a building and communicates directly with the service provider. Continuing the example of XML, a gateway computer can infer from the data model itself which service provider is pertinent to particular data describing the current condition of a building on the basis of XML encoding such as, for example:

<futureCondition id=“Heat Sensor” contact=“Fire Department>
</futureCondition >
<futureCondition id=“Security System” contact=“Police”>
</futureCondition >
<futureCondition id=“Motion Detector” contact=“Police”>
</futureCondition >

Methods and systems for providing services with respect to buildings according to the example of FIG. 3 typically also include parsing (134) the data model expressed in a markup language (140) into a display format (136) and displaying (142) an image (130) of the building represented in the data model including a projected future condition of the building. XML parsers are available for parsing XML. One example of an XML parser is “Expat,” an open source parser originally developed by Jim Clark of the Thai Open Source Software Center Ltd., Bangkok, Thailand, and now sponsored by the open source development site Open Source Development Network. See www.SourceForge.net and www.expat.sourceforge.net for more details on the Expat XML parser.

Expat is a sophisticated XML parser. Simpler parsers may be advantageous for some embodiments of the present invention. Particularly in the case of home security and emergency services, small, fast data models with small fast parsers maybe more useful. Some implementers may wish to develop their own parsers, optimizing both the parser and an XML data model to work together for size, speed, and often for a particular 3D API. An example of an XML format designed to work with a particular API is “XGL,” an XML format designed particularly for use with OpenGL. XGL is specified by the ‘XGL Working Group,’ and its specification can be obtained from their website at www.xglspec.org.

A display format is client code formatted to display graphic images through a 3D graphics API (138). Display format, client code for 3D graphics APIs, can be expressed in many programming languages including particularly C, Basic, C++, and Java, but also other as will occur to those of skill in the art. Examples of such APIs include those in OpenGL and Java 3D. “OpenGL” is a standard 3D graphics environment, originally developed by Silicon Graphics, Inc., of Mountain View, Calif., now defined by an independent industry consortium called the OpenGL Architecture Review Board. OpenGL provides, among other things, a standard procedural API for use by client code in generating and displaying 3D images. The OpenGL API can be used to create image from pixel data or from geometric vertices. Sun Microsystems, Inc., of Santa Clara, Calif., provides the 3D graphics API called “Java 3D.” Although OpenGL is not a Java application as such, Java interfaces for OpenGL are available.

FIG. 3 also illustrates a method for providing services with respect to a building that includes receiving (146) at a service provider (102) who provides services (124) with respect to the building a data model (112) expressed in a markup language (140), the data model comprising a three-dimensional representation (114) of the building and a projected future condition (115) of the building; parsing (134) the data model expressed in a markup language (140) into a display format (136); displaying (142) an image (130) of the building represented in the data model including a projected future condition of the building; and altering the services provided with respect to the building in dependence upon the displayed image. In this example, a service provider, or rather, a service provider's computer receives a data model expressed in a markup language such as, for example, XML. ‘Receiving’ typically is carried out through a networked coupling for data communications over, for example, TCP/IP or HTTP, and parsing (134) and displaying (142) are carried out on a security provider computer.

Turning again to FIG. 2, it is useful to note for purposes of understanding the particular usefulness of various embodiments of the present invention, that in many embodiments, the method of FIG. 2 includes repeating (144) in near-real-time the steps of projecting (150) the future condition (115) of the building (1 24) and tailoring (1 22) services with respect to the building. Consider an example in which a fireman approaches a burning house. The fireman is holding a wireless networked handheld device such as a network enabled PDA upon which is displayed projected future conditions of the house. As the fireman approaches the burning house, a stream of XML data modeling the house, including projected future conditions of the house, is downloaded across the Internet from a gateway computer in the house to the handheld device in the fireman's hand where it is parsed and displayed on a display screen on the handheld device. Projected future conditions of the house are displayed as text or icons at appropriate locations in a 3D image of the house. The projected future conditions of the house indicate that by the time the fireman actually arrives at the house the entire house will be filled with smoke and high temperatures with the single exception of one upstairs bedroom. The fireman therefore tailors fire fighting services with respect to the house to provide a ladder entry through the window of that upstairs bedroom. The projected future conditions of the house displayed on the fireman's PDA are updated in near real time, so that shortly after the fireman begins fighting the fire through the upstairs bedroom, a projected future condition of the house displayed on the fireman's PDA indicates that the roof of the house is in immanent danger of collapse. The fireman tailors fire fighting services with respect to the house by exiting the house, back through the window of the upstairs bedroom and down the ladder, to continue fire fighting activities from outside the house.

Repeating (144) the steps of projecting (150) the future condition (115) of the building (124) and tailoring (122) services with respect to the building occurs in ‘near real time’ in the sense that the gateway computer updates service provider computers with the latest data describing a projected future condition of the building as soon as the gateway computer receives new current condition data from sensors and executes a projection. As a police officer approaches as residence containing a possibly dangerous intruder, therefore, the police officer's handheld wireless computer is updated with projections of the intruder's future moves in the house as the intruder moves from room to room. As a fire truck approaches a burning house or office building, a 3D image of the building is updated with data describing projected future temperature and smoke detection status in each room of the building having electronic thermometers or smoke detectors as well as projected future conditions of the house for use by fire fighters in tailoring fire fighting services with respect to the building. In this way, therefore, services with respect to a building are tailored to respond to projected future conditions of a building as they change in near real time.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for providing services with respect to a building, the method comprising:
depicting a building in a data model, the data model comprising a three-dimensional representation of the building, a current condition of the building, a projected future condition of the building, and, optionally, one or more previous conditions of the building;
projecting the future condition of the building in dependence upon the current condition of the building and, optionally, in dependence upon one or more previous conditions of the building; and
tailoring services with respect to the building in dependence upon the projected future condition of the building.

2. The method of claim 1 wherein depicting a building in a data model comprises describing the building, including the projected future condition of the building in a markup language.

3. The method of claim 1 wherein projecting the future condition of the building further comprises:
asserting into a rules base the current condition of the building; and
querying the rules base for a projected future condition of the building

4. The method of claim 1 wherein projecting the future condition of the building is carried out in dependence upon one or more previous conditions of the building

5. The method of claim 1 wherein projecting the future condition of the building further comprises statistically projecting the future condition of the building in dependence upon values of data describing the current condition of the building and values of data describing one or more previous conditions of the building.

6. The method of claim 1 further comprising receiving in a gateway computer, from sensors within the building, data describing the current condition of the building.

7. The method of claim 1 wherein tailoring services further comprises communicating the data model, including the future condition of the building, from the gateway computer to service providers who provide services with respect to the building

8. The method of claim 1 wherein tailoring services further comprises communicating the data model expressed in a markup language, including the projected future condition of the building, from the gateway computer to service providers who provide services with respect to the building, and the method further comprises:
parsing the data model expressed in a markup language into a display format; and
displaying an image of the building represented in the data model including projected future condition of the building.

9. The method of claim 1 further comprising repeating in near-real-time the steps of projecting the future condition of the building and tailoring services with respect to the building.

10. A method for providing services with respect to a building, the method comprising:
receiving at a service provider who provides services with respect to the building a data model expressed in a markup language, the data model comprising a three-dimensional representation of the building and a projected future condition of the building;
parsing the data model expressed in a markup language into a display format;
displaying an image of the building represented in the data model including the projected future condition of the building, and
altering the services provided with respect to the building in dependence upon the displayed image.

11. A system for providing services with respect to a building, the system comprising:
means for depicting a building in a data model, the data model comprising a three-dimensional representation of the building, a current condition of the building, a projected future condition of the building, and, optionally, one or more previous conditions of the building;
means for projecting the future condition of the building in dependence upon the current condition of the building and, optionally, in dependence upon one or more previous conditions of the building; and
means for tailoring services with respect to the building in dependence upon the projected future condition of the building.

12. The system of claim 11 wherein means for depicting a building in a data model comprises means for describing the building, including the projected future condition of the building in a markup language.

13. The system of claim 11 wherein means for projecting the future condition of the building further comprises:
means for asserting into a rules base the current condition of the building; and
means for querying the rules base for a projected future condition of the building.

14. The system of claim 11 wherein means for projecting the future condition of the building is carried out in dependence upon one or more previous conditions of the building.

15. The system of claim 11 wherein means for projecting the future condition of the building further comprises means for statistically projecting the future condition of the building in dependence upon values of data describing the current condition of the building and values of data describing one or more previous conditions of the building.

16. The system of claim 11 further comprising means for receiving in a gateway computer, from sensors within the building, data describing the current condition of the building.

17. The system of claim 11 wherein means for tailoring services further comprises means for communicating the data model, including the future condition of the building, from the gateway computer to service providers who provide services with respect to the building.

18. The system of claim 11 wherein means for tailoring services further comprises means for communicating the data model expressed in a markup language, including the projected future condition of the building, from the gateway computer to service providers who provide services with respect to the building and the system further comprises:
means for parsing the data model expressed in a markup language into a display format; and
means for displaying an image of the building represented in the data model including projected future condition of the building.

19. The system of claim 11 further comprising means for repeating in near-real-time the steps of projecting the future condition of the building and tailoring services with respect to the building.

20. A system for providing services with respect to a building, the system comprising:
means for receiving at a service provider who provides services with respect to the building a data model expressed in a markup language, the data model comprising a three-dimensional representation of the building and a projected future condition of the building;
means for parsing the data model expressed in a markup language into a display format;
means for displaying an image of the building represented in the data model including the projected future condition of the building, and
means for altering the services provided with respect to the building in dependence upon the displayed image.

21. A computer program product for providing services with respect to a building, the computer program product comprising:
a recording medium;
means, recorded on the recording medium, for depicting a building in a data model, the data model comprising a three-dimensional representation of the building, a current condition of the building, a projected future condition of the building, and, optionally, one or more previous conditions of the building,
means, recorded on the recording medium, for projecting the future condition of the building in dependence upon the current condition of the building and, optionally, in dependence upon one or more previous conditions of the building; and
means, recorded on the recording medium, for tailoring services with respect to the building in dependence upon the projected future condition of the building

22. The computer program product of claim 21 wherein means, recorded on the recording medium, for depicting a building in a data model comprises means, recorded on the recording medium, for describing the building, including the projected future condition of the building in a markup language.

23. The computer program product of claim 21 wherein means, recorded on the recording medium, for projecting the future condition of the building further comprises:
means, recorded on the recording medium, for asserting into a rules base the current condition of the building; and
means, recorded on the recording medium, for querying the rules base for a projected future condition of the building.

24. The computer program product of claim 21 wherein means, recorded on the recording medium, for projecting the future condition of the building is carried out in dependence upon one or more previous conditions of the building.

25. The computer program product of claim 21 wherein means, recorded on the recording medium, for projecting the future condition of the building further comprises means, recorded on the recording medium, for statistically projecting the future condition of the building in dependence upon values of data describing the current condition of the building and values of data describing one or more previous conditions of the building.

26. The computer program product of claim 21 further comprising means, recorded on the recording medium, for receiving in a gateway computer, from sensors within the building, data describing the current condition of the building.

27. The computer program product of claim 21 wherein means, recorded on the recording medium, for tailoring services further comprises means, recorded on the recording medium, for communicating the data model, including the future condition of the building, from the gateway computer to service providers who provide services with respect to the building.

28. The computer program product of claim 21 wherein means, recorded on the recording medium, for tailoring services further comprises means, recorded on the recording medium, for communicating the data model expressed in a markup language,
including the projected future condition of the building, from the gateway computer to service providers who provide services with respect to the building, and the computer program product further comprises:
means, recorded on the recording medium, for parsing the data model expressed in a markup language into a display format; and
means, recorded on the recording medium, for displaying an image of the building represented in the data model including projected future condition of the building.

29. The computer program product of claim 21 further comprising means, recorded on the recording medium, for repeating in near-real-time the steps of projecting the future condition of the building and tailoring services with respect to the building.

30. A computer program product for providing services with respect to a building the computer program product comprising:
a recording medium;
means, recorded on the recording medium, for receiving at a service provider who provides services with respect to the building a data model expressed in a markup language, the data model comprising a three-dimensional representation of the building and a projected future condition of the building;
means, recorded on the recording medium, for parsing the data model expressed in a markup language into a display format;
means, recorded on the recording medium, for displaying an image of the building represented in the data model including the projected future condition of the building; and
means, recorded on the recording medium, for altering the services provided with respect to the building in dependence upon the displayed image.
